(19) United States
(12) Patent Application Publication
(10) Pub. No.: US 2004/0010441 A1
(43) Pub. Date: Jan. 15, 2004

(54) Metrics analyzer tool and method

(75) Inventors: Murali K. Nandigama, San Jose, CA (US); Alfredo J. Muir, Mountain View, CA (US); Philip A. Chin, San Jose, CA (US); Timothy Riley, San Jose, CA (US)

Correspondence Address: MARTINE & PENILLA, LLP, 710 LAKEWAY DRIVE, SUITE 170, SUNNYVALE, CA, 94085, US

(73) Assignee: SUN MICROSYSTEMS, INC.

(21) Appl. No.: 10/195,080

(22) Filed: Jul. 12, 2002

(51) Int. Cl. G06F 17/60

(52) U.S. Cl. 705/10

(57) ABSTRACT

Methods and a system for mapping metrics to goals of an organization in order to track process improvement are provided. One exemplary method is a computer implemented method for capturing a set of metrics to achieve targeted goals of an organization is provided. The method initiates with establishing goals of an organization. Then, questions related to each of the goals are identified. The identifying questions operation includes assigning a question relevancy factor to each of the questions indicating a degree of relevance with each of the goals related to the questions. Next, metrics providing answers to each of the questions are identified. The identifying metrics operation includes assigning a metric relevancy factor to each metric indicating a degree of relevance with each of the questions answered by the metrics. Then, a cutoff relevancy is determined. Next, a set of metrics assigned a metric relevancy factor that is equal to or greater than the cutoff relevancy is proposed, wherein the set of metrics provide answers to questions having a question relevancy factor that is equal to or greater than the cutoff relevancy. A computer readable media having program instructions for capturing a set of metrics to achieve targeted goals of an organization is also provided.

### BACKGROUND OF THE INVENTION

1. Field of the Invention

This invention relates generally to methods for evaluating process improvement and more particularly to a method and a tool for mapping goals of an organization to metrics which provide feedback on the achievement of reaching those goals.

2. Description of the Related Art

Organizations can be formed for profitable missions and non-profitable missions. With respect to profitable missions, mature companies typically spend a great deal of effort and thought in defining the missions of the organization. Once the missions are decided upon, they are disseminated to the employees of the company. This dissemination is usually handled in a top-down approach where executive management presents missions of the organization to the employees.

The Goals, Questions and Metrics (GQM) approach is one approach to define metrics that need to be measured to determine if the organization's goals are being achieved. The GQM approach is used to decide what the metrics are that need to be collected to track the given goals. One shortcoming of the GQM approach is that deciding the right metrics to answer questions about the goals is relatively undefined. Additionally there are a large number of metrics to choose from and this large number is too great for one person to have complete knowledge of the entire group. Thus, even within the same organization, divisions having the same goals may choose different metrics to measure the progress towards the same goals. This lack of standardization is detrimental to the organization as the differing metrics can direct the divisions within the same organization down differing paths toward process improvement, thereby fracturing the organization rather than synchronizing the divisions.

The selection of the proper metrics and implementation of those metrics in the correct process will guide an organization's process improvement towards sustained profitability. For example, in reference to software process improvement, the proper metrics guide the organization towards the Software Engineering Institute's Capability Maturity Module (SEI-CMM) or Six Sigma methodologies, both of which help organizations focus on developing and delivering near perfect products and services.

It is also important to choose the proper number of metrics to evaluate. All too often, organizations, both large and small, decide to take a shotgun approach and measure all the metrics thought of because of the lack of knowledge as to which metric will be yield representative information. Thus, an abundance of information is generated but the usefulness of the information is questionable at best. Furthermore, the capital investment and personnel resources required to generate this questionable data is expensive and wasteful for the organization.

As a result, there is a need to solve the problems of the prior art to provide a tool to assist organizations in standardization of the mapping of goals to metrics such that the data from the metrics is indicative of the organizations progress in achieving its goals.

### SUMMARY OF THE INVENTION

Broadly speaking, the present invention fills these needs by providing a method and system that defines a library of metrics that is mapped to a set of goals through multiple questions connecting the metric to the goal to determine if the goals are being achieved. It should be appreciated that the present invention can be implemented in numerous ways, including as a process, a system, or a device. Several inventive embodiments of the present invention are described below.

In one embodiment, a method for standardizing a choice of metrics that provide information as to an organization's progress in achieving goals of the organization is provided. The method initiates with mapping a goal to a question related to the goal. The mapping includes defining a relevancy of the question to the goal. Then, the question is mapped to the metric related to the question. The mapping here includes defining a relevancy of the metric to the question. Next, a threshold relevancy indicating a minimum relevancy for the metric to be related to the question and the question to be related to the goal is defined. Then, it is determined if the metric is required to indicate achievement of the goal.

In another embodiment, a method for defining a minimum number of metrics sufficient to measure in order to determine the achievement of a goal is provided. The method initiates with defining a library of metrics in a metrics' database. Then, each of the metrics in the metrics' database is mapped to a corresponding question in a questions' database. Next, the corresponding question is mapped to a goal in a goals' database. Then, input from at least two sources is provided as to a relevance factor for each metric of a set of the metrics from the library to the goal. Next, a cutoff relevance is defined. Then, the input from the at least two sources is sorted to define common metrics, wherein the relevance factor for each of the common metrics is equal to or greater than the cutoff relevance.

In yet another embodiment, a computer implemented method for capturing a set of metrics to achieve targeted goals of an organization is provided. The method initiates with establishing goals of an organization. Then, questions related to each of the goals are identified. The identifying questions includes assigning a question relevancy factor to each of the questions indicating a degree of relevance with each of the goals related to the questions. Next, metrics providing answers to each of the questions are identified. The identifying metrics includes assigning a metric relevancy factor to each metric indicating a degree of relevance with each of the questions answered by the metrics. Then, a cutoff relevancy factor is determined. Next, a set of metrics where each metric of the set of metrics has the metric relevancy factor having a value equal to or greater than the cutoff relevancy is proposed, wherein the set of metrics provide answers to questions having the question relevancy factor being equal to or greater than the cutoff relevancy.

In still yet another embodiment, a computer readable media having program instructions for capturing a set of metrics to achieve targeted goals of an organization is provided. The computer readable media includes program instructions for establishing goals of the organization and program instructions for identifying questions related to each of the goals. The program instructions for identifying questions include program instructions for assigning a question relevancy factor to each of the questions indicating a degree of relevance with each of the goals related to the questions. Program instructions for identifying metrics providing answers to each of the questions are provided. The program instructions for identifying metrics include program instructions for assigning a metric relevancy factor to each metric indicating a degree of relevance with each of the questions answered by the metrics. Program instructions for determining a minimum relevancy factor are included. Program instructions for proposing a set of metrics where each metric of the set of metrics is assigned the metric relevancy factor having a value that is equal to or greater than the cutoff relevancy, wherein the set of metrics provide answers to questions having the question relevancy factor being equal to or greater than the cutoff relevancy are also included.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic pictorially illustrating a method of relating metrics to goals of an organization in accordance with one embodiment of the invention.

FIG. 2 is a schematic of a configuration of a goals' database where questions are mapped to each goal in accordance with one embodiment of the invention.

FIG. 3 is a schematic of a configuration of a questions' database where metrics are mapped to each question in accordance with one embodiment of the invention.

FIG. 4 is a schematic of a configuration of a metrics' database containing a library of metrics in accordance with one embodiment of the invention.

FIG. 5 is a flowchart diagram of the method operations for mapping goals, questions and metrics in accordance with one embodiment of the invention.

FIG. 6 is a schematic diagram of a graphical user interface (GUI) being displayed on a computer monitor for mapping goals, questions and metrics and defining relevancy factors in accordance with one embodiment of the invention.

### DETAILED DESCRIPTION OF THE PREFERRED EMBODIMENTS

An invention is described for an automated tool to assist in the evaluation of goals for an organization by identifying relevant metrics related to the goals. It will be obvious, however, to one skilled in the art, that the present invention may be practiced without some or all of these specific details. In other instances, well known process operations have not been described in detail in order not to unnecessarily obscure the present invention.

The embodiments of the present invention provide a tool that enables an organization to efficiently define relevant metrics so that progress toward goals mandated by an organization can be tracked in order to verify attainment of the goals. In one embodiment, the tool includes a database engine having a library of metrics. The library of metrics is a library of approximately 500 individual software metrics related to software management and engineering when the tool is used for software process improvement (SPI). Also included in the database engine is a questions' database and a goals' database. The databases are configured so that each metric is mapped to a question and each question is mapped to a goal. Consequently, the relationship of each metric to each goal can be determined. As used herein, a metric is data to benchmark against a result, i.e., a goal. In other words, a metric is a standard of measurement. Broadly speaking, the embodiments of the present invention provide a search engine for process improvement. It should be appreciated that while the examples provided herein are related to the software industry, the examples are illustrative and not meant to be limiting. That is, the embodiments defined herein are applicable to any industry interested in process improvement, such as the pharmaceutical industry, the auto industry, the steel industry, etc.

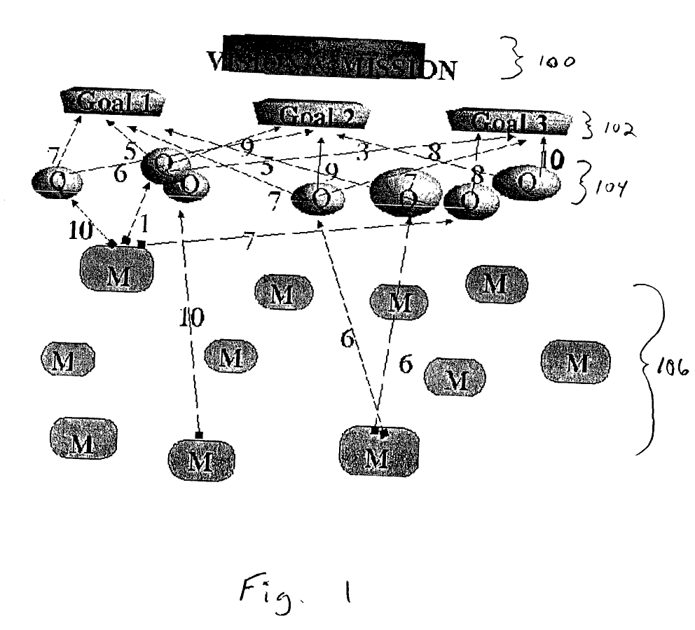

FIG. 1 is a simplified schematic pictorially illustrating a method of relating metrics to goals of an organization in accordance with one embodiment of the invention. Here, Vision and Mission 100 is defined by the organization. For example an executive committee of the organization may define Vision and Mission 100 in a statement that disseminated to the organization. From Vision and Mission 100, goals 102 are defined. Goals 102 may be results aimed at achieving Vision and Mission 100 in one embodiment. Questions 104 are asked in order to determine how to achieve goals 102. Of course, a single question can be related to one or multiple goals 102. One skilled in the art will appreciate that questions 104 include the how, what, why, when where, etc., types of questions for achieving goals 102. Metrics 106 provides an answer to a corresponding question 104.

In one embodiment, questions 104 and metrics 106 are assigned relevance factors which indicate a degree of relevancy for the questions to goals 102 and the metrics to the questions in one embodiment. The relevancy factor is based upon some predetermined scale, such as one (1) to ten (10), as illustrated in FIG. 1, where 1 indicates a low relevance and ten indicates a high relevance. Of course other predetermined scales may be used to indicate a degree of relevancy. As will be discussed in more detail below, the method can sort the metrics because of the known relationship between metrics 106, questions 104 and goals 102. In addition, metrics 106 can be sorted so that the metrics that have a minimum degree of relevancy are considered worthwhile for measuring the corresponding goal, while metrics not having a minimum degree of relevancy are not further considered with respect to the goal due to the low relevancy set by the user.

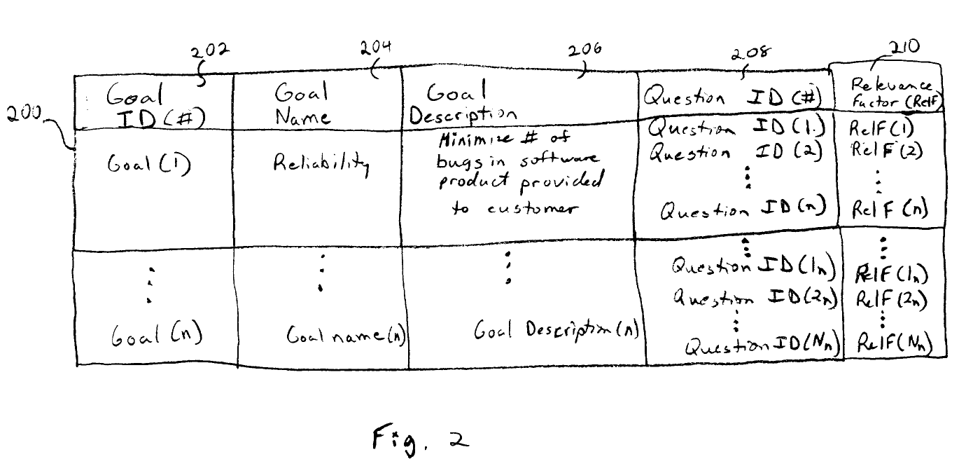

FIG. 2 is a schematic of a configuration of a goals' database where questions are mapped to each goal in accordance with one embodiment of the invention. In one embodiment, goals' database 200 includes data entries for goal identification (ID) 202, goal name 204, goal description 206, question identification (ID) 208 and relevance factor 210. Goal ID 202 can be a number or alphanumeric entry sequentially assigned to each goal in one embodiment. Goal name 204 is a broad categorization of goal description 206. Question ID 208 indicates relevant questions for each goal ID 202. Relevance factor (RelF) 210 indicates a degree of relevance for each question associated with a goal. In one embodiment, relevance factor 210 is an integer from one (1) to ten (10) where 1 indicates low relevance and 10 indicates high relevance. One skilled in the art will appreciate that goals' database 200 may be a relational data table in accordance with one embodiment.

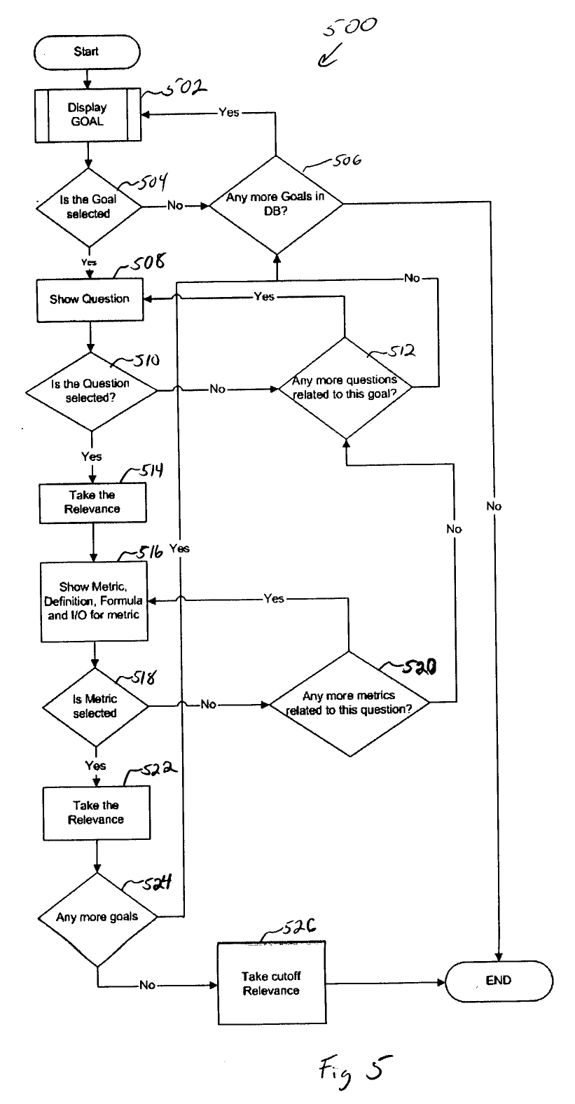

As an exemplary illustration, goal name 204 is reliability. Goal description 206 for reliability is to minimize the number of bugs in a software product provided to customers. Question ID (1) through Question ID (n) are relevant to goal (1). As mentioned above, question IDs (1-n) are the questions that need to be answered in order to reach the goal, which in this example is reliability. Each goal is related to at least one question and each question is associated with a relevance factor indicating how relevant the question is to the goal. In one embodiment, a user defines the relevance factor as will be explained in more detail below with reference to FIG. 5.

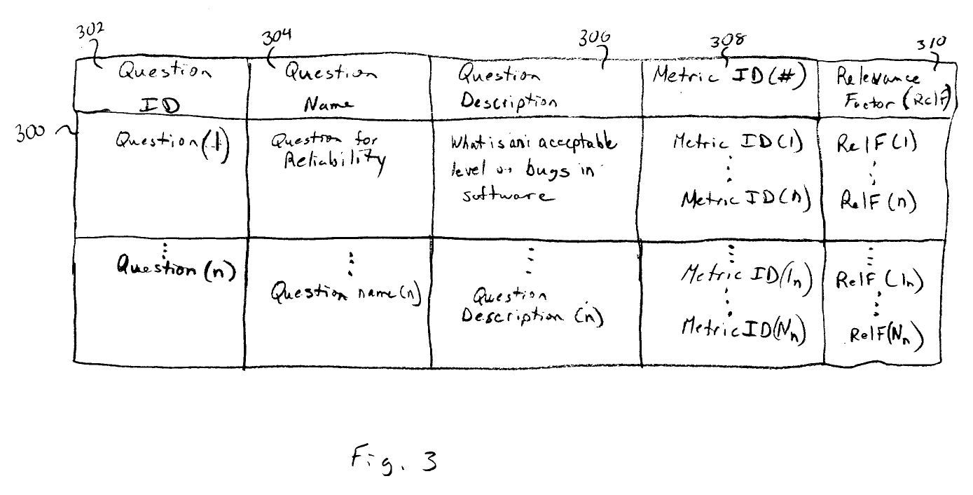

FIG. 3 is a schematic of a configuration of a questions' database where metrics are mapped to each question in accordance with one embodiment of the invention. In one embodiment, questions' database 300 includes data entries for question identification (ID) 302, question name 304, question description 306, question identification (ID) 308 and relevance factor 310. Question ID 302 can be a number or alphanumeric entry sequentially assigned to each question in one embodiment. Question name 304 is a name for question ID 302. Metric ID 308 indicates relevant metrics for each question ID 302. Relevance factor (RelF) 310 indicates a degree of relevance for each metric associated with a question. In one embodiment, relevance factor 310 is an integer from one (1) to ten (10) where 1 indicates low relevance and 10 indicates high relevance. One skilled in the art will appreciate that questions' database 300 may be a relational data table in accordance with one embodiment.

As an exemplary illustration, question name 304 is a question for reliability. Question description 306 details a question relevant to a corresponding goal, such as goal (1) of FIG. 2. For example, question description 306 asks what is an acceptable level of bugs in the software to meet the reliability goal. Metric ID (1) through Metric ID (n) are relevant to question (1). As mentioned above, question IDs (1-n) are the questions that need to be answered in order to reach the goal, which in this example is reliability. Each question is related to at least one metric and each metric is associated with a relevance factor indicating how relevant the metric is to the question. In one embodiment, a user defines the relevance factor as will be explained in more detail below with reference to FIG. 5. It should be appreciated that FIG. 3 maps the metrics to the questions and FIG. 2 maps the questions to the goals. Accordingly, the corresponding metrics for each goal can be easily obtained through the above described database configuration. In addition, the relevance factor allows for sorting the metrics and the questions so that a certain minimum relevance factor is required or the corresponding metric or question is sorted/filtered out. FIGS. 2 and 3 illustrate a column containing relevance factors as part of the table. Alternatively, the relevance factors can be incorporated through business logic being executed in the background, as will be apparent to one skilled in the art.

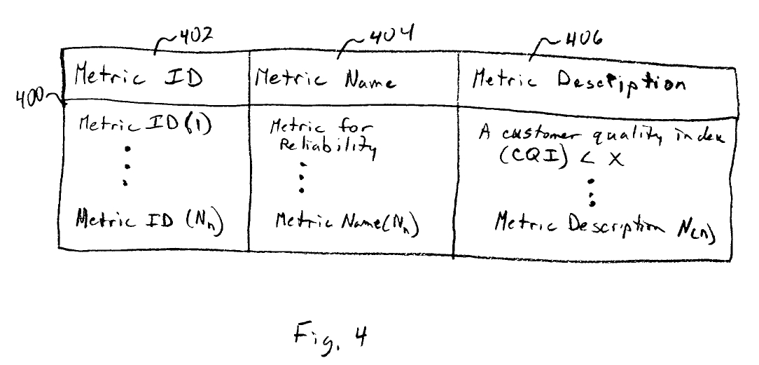

FIG. 4 is a schematic of a configuration of a metrics database containing a library of metrics in accordance with one embodiment of the invention. Metrics' database 400 includes metric ID 402, metric name 404 and metric description 406. Continuing with the example discussed with reference to FIGS. 2 and 3, metric name 404 would be a metric for reliability, i.e., the metric is used as a measure of reliability. For example, the metric may be a customer quality index (CQI) which represent incidents or bugs in software delivered to a customer. One skilled in the art will appreciate that the CQI can also be used as a metric for customer satisfaction. As described above with reference to FIG. 1, each metric may be associated with multiple questions and each question may be associated with multiple goals. Therefore, each metric can be related to multiple goals.

In reference to the software industry, as many as 487 software metrics have been identified across 74 categories, such as manufacturing, process control, research and development, quality control, etc. A survey of 14 authors, including Davidson, Garrison, Kan et al., identified 12 common classes of software metrics from the 74 categories. By mapping the questions to the goals and then mapping the goals to the metrics, a reproducible process is defined that allows organizations to standardize the decision process for determining which metrics to use to achieve goals of the organization. Thus, for large or small organizations, a higher confidence level is established for the organization in reference to being assured that the metrics are an accurate measure of the goals. In addition, the database allows for multiple managers of a division to assign a relevance factor to metrics and question. Then, common metrics chosen by the mangers can be used rather than a laundry list of metrics developed by a shotgun approach. In one embodiment, the common metrics can be arrived at by finding the intersection of the metrics chosen by each manager. It should be appreciated that each of the tabular format databases described with reference to FIGS. 2-4 is scalable and adaptable. Thus, as new metrics become available they can be mapped accordingly. New goals may be developed by the organization over time, especially as an organization progresses from a young company to a mature company.

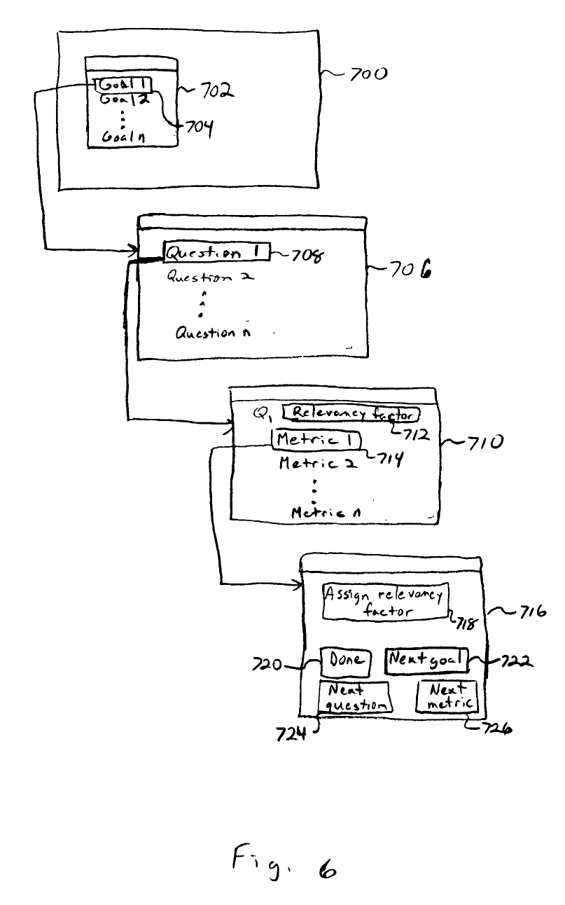

FIG. 5 is a flowchart diagram of the method operations for mapping goals, questions and metrics in accordance with one embodiment of the invention. Flowchart 500 initiates with operation 502 where a goal is displayed. Here, a list of goals from the goals' database described with reference to FIG. 2 can be displayed in one embodiment. The list of goals can be presented as a window of a graphical user interface (GUI) as discussed in more detail with reference to FIG. 6. The method then advances to decision operation 504 where a user is queried as to whether the user would like to select the displayed goal. If the user would not like to select the displayed goal, the method moves to decision operation 506 where it is determined if there are any more goals in the database. If there are more goals in the database, the method returns to operation 502 and the method repeats as described above. If there are no more goals in the database then the method terminates.

If the user desires to select the goal in operation 504, then the method moves to operation 508 where a question mapped to the goal is shown. With reference to FIG. 2, the question shown includes the questions mapped to the goals in the goals' database. In one embodiment, the questions are presented sequentially in the order defined by the goals database of FIG. 2. Alternatively, the questions can be grouped and presented as a window of a GUI as will be explained in more detail with reference to FIG. 6. The method then proceeds to decision operation 510 where the user is queried if they desire to choose the question shown in operation 508. If the user would not like to choose the question then the method advances to decision operation 512 where it is determined if there are any other questions related to this goal. Here again, the questions mapped to the goals in the goals' database provides the information to determine if there are more questions related to this goal. If there are more questions related to the goal, then the method returns to operation 508. If there are no more questions related to the goal, then the method moves to decision operation 506 and proceeds as discussed above.

If the question is selected in operation 510, the method advances to operation 514 where the relevance of the question to the goal is provided. Here, a relevance factor is entered by a user in one embodiment. As discussed above the relevance factor can be defined by any sliding scale configured to differentiate a degree of relevancy between the questions that are related to a goal. The method then proceeds to operation 516 where the metric related to the question is provided. In addition the definition, formula and input/output (I/O) for the metric is provided here. With reference to FIG. 3, suitable metrics include the metrics mapped to the questions in the questions' database. The method then proceeds to decision operation 518 where a user is queried if the user would like to choose the metric identified in operation 516. As mentioned above with respect to questions, the metrics are presented sequentially in the order defined by the questions' database of FIG. 3 in one embodiment. Alternatively, the metrics can be grouped and presented as a window of a GUI as will be explained in more detail with reference to FIG. 6.

If the user would not like to choose the metric in decision operation 518, then the method moves to decision operation 520 where it is determined if any more metrics are related to the question. If there are more metrics related to the question, then the method returns to operation 516 where another metric is shown as described above. If there are no more metrics related to the question then the method advances to operation 512 where it is determined if any more questions are related to the goal. From operation 512, the method proceeds as described above.

If the user would like to choose the selected metric in decision operation 518, then the method advances to operation 522 where the relevance of the metric to the question is provided. Here, the degree of relevance is similar to the degree of relevance discussed above for the question/goal provided in operation 514. The method then proceeds to operation 524 where a user is queried whether they would like to choose any more goals. If a user would not like to choose any more goals then the method proceeds to operation 526 where a cutoff relevance is provided. The cutoff relevance is a filtering criteria that is used to segregate the questions and the metrics selected according to the relevance provided in operations 514 and 522, respectively. That is, questions and metrics having a relevance equal to or greater than the threshold relevance would be considered an applicable question or metric for the goal. More particularly, if the relevance was based on a scale of 1 to 10, with a 1 indicating a low relevance and a 10 indicating a high relevance, the threshold relevance can be set to 7, in one embodiment. Thus, any questions with a relevance factor of 7 or greater are considered relevant, while questions with a relevance factor less than 7 are not considered further. One skilled in the art will appreciate that this type of filtering eliminates a plethora of questions and metrics being tracked by the organization.

If the user would like to select more goals in decision operation 524, then the method proceeds to decision operation 506 where it is determined if there are any more goals in the database. The method then proceeds as described above until a user has selected all the applicable goals, questions and metrics and defined the question and metric relevance and the cutoff relevance.

It should be appreciated that upon the completion of the method operations of FIG. 5 the metrics are mapped to the questions and the questions are mapped to the goals, therefore, the metrics can be associated to the goals through the questions. Thus, by building a library of metrics, such as the library of metrics with reference to FIG. 4, and performing the mapping operations of FIG. 5, a tool allowing for the minimal metrics sufficient to achieve a goal is provided. Moreover, the inclusion of a relevance factor in conjunction with the relevance cutoff, i.e., threshold relevance, allow for further narrowing in on appropriate metrics efficiently. In one embodiment, multiple managers of a division may map the questions to the metrics and the goals to the questions differently. However, common metrics between the mappings can be ascertained to be used as a starting point for measuring achievement of the goals by the division.

FIG. 6 is a schematic diagram of a graphical user interface (GUI) being displayed on a computer monitor for mapping goals, questions and metrics and defining relevancy factors in accordance with one embodiment of the invention. Computer monitor 700 displays window 702 which sequentially lists goals. In one embodiment, the goals are accessed from a goals' database with reference to FIG. 2. A user can select goal 1 704 by clicking on goal 1. The selection of goal 1 704 generates window 706 where the questions associated with goal 1 are displayed. A user can then choose question 1 708 by clicking on question 1 to generate window 710. Window 710 displays the metrics associated with question 1 708. It should be appreciated that the metrics can be displayed by a name, a formula, a use, etc. Window 710 also provides dialogue box 712 allowing a user to enter a relevancy factor for question 1 708. As described above the relevancy factor indicates a degree of relevance of question 1 708 to goal 1 704.

Still referring to FIG. 6, the user can choose a metric, such as metric 1 714, to generate window 716 where a relevancy factor can be assigned in dialogue box 718. The relevancy factor here indicates a degree of relevance of metric 1 714 to question 1 708. Once the relevancy factor is assigned the user has the choice of exiting by selecting done button 720, or returning to display windows 702, 704 and 706 by selecting next goal button 722, next question button 724 or next metric button 726, respectively. It should be appreciated that in response to selecting done button 720, the user can be presented with a window that displays the questions and metrics for each selected goal. In one embodiment, the questions and metrics can be filtered and sorted so that only questions or metrics having a threshold relevance are displayed. It should be appreciated that as used herein threshold relevance and weight factor can represent the same concept, which is a minimum degree of relevance in order to be further considered.

In summary, the above described embodiments provide a method and a tool for providing metrics from a library of metrics and relating the relevance of each metric to a goal associated with the metric. Goals, such as reliability, customer satisfaction, quality levels, etc. are measured through metrics such as customer quality index (CQI), total defect containment effectiveness (TDCE), etc. TABLE 1 illustrates an example of goals and associated metrics for a software application. It should be appreciated that the goals and metrics listed below are exemplary and not meant to be limiting.

TABLE 1

| | | Processes to be brought under | |
|---|---|---|---|
| GOAL DESCRIPTION | OBJECTIVE/APPROACH | quantitative control | ASSOCIATED METRICS |
| Goal 1 | Estimating based on . . . | Requirement capturing | Schedule slippage |
| Improve estimation and | Planning based on estimation | Estimating size, effort | Effort slippage |
| planning | Tracking actual against plan | & schedule | Productivity |
| | Identifying changes | Project planning | Backlog |
| | Re-estimating and re-planning | Project tracking | Management Index |
| | | | Response Time |
| | | | Index |
| Goal 2 | Monitoring the quality | Document and code | In process defect |
| Decrease software | | reviews | density |
| defects | Restrict at least X % of the total defects | All types of testing | Total defect |
| | prior to delivery | | containment |
| | | | effectiveness |
| | Identify and remove all injected | | Bad Fix |
| | defects of each life cycle phase | | |
| Goal 3 | Detecting early errors | Project monitoring | In process review |
| Reduce Cost | Monitoring of non-value added cost | Reviews | efficiency |
| | | | Effort spent on |
| | | | reviews and testing |
| | | | Effort spent on |
| | | | rework |
| | | | Phase containment |
| | | | effectiveness |
| | | | Review |
| | | | Effectiveness |

It should be appreciated that the tool described herein allows a user to choose a goal and be presented with metrics associated with that goal. Of course, each business situation can have unique situations, therefore, a user can assign a degree of relevance between the goals, questions and metrics. In effect, a user can apply standardized goals and metrics and customize the relation of the goals and the metrics to each user's situation. It should be appreciated that the metrics listed in Table 1 are a subset of metrics used in the software industry. One skilled in the art will appreciate that any metric can be defined as a mathematical equation or formula.

Accordingly, the tool described herein allows a user to customize a standardized list of goals and metrics in order to achieve sustained profitability. It will be apparent to one skilled in the art that the method and tool can work equally as well in a reverse direction. That is, if a data point or metric is being captured by an organization, the tool can trace the metrics back to the corresponding goals that the metrics are mapped to through the questions. Thus, the organization is enabled to verify that the metrics are aligned with the goals.

The above described invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a communications network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for standardizing a choice of metrics providing information as to an organization's progress in achieving goals of the organization, comprising:
mapping a goal to a question related to the goal, the mapping a goal including;
defining a relevancy of the question to the goal;
mapping the question to a metric related to the question, the mapping the question including;
defining a relevancy of the metric to the question;
defining a threshold relevancy indicating a minimum relevancy for the metric to be related to the question and the question to be related to the goal; and
determining if the metric is required to indicate achievement of the goal.

2. The method of claim 1, further including:
defining a metrics' database having a library of metrics;
defining a questions' database having a plurality of questions related to metrics of the library of metrics; and
defining a goals' database having a plurality of goals related to questions of the questions' database.

3. The method of claim 1, wherein the goal is related to software process improvement.

4. The method of claim 2, wherein the library of metrics includes metrics directed toward software process improvement

5. A method for defining a minimum number of metrics sufficient to measure in order to determine the achievement of a goal, comprising:
defining a library of metrics in a metrics' database;
mapping each of the metrics in the metrics' database to a corresponding question in a questions' database;
mapping the corresponding question to a goal in a goals' database;
providing input from at least two sources as to a relevance factor for each metric of a set of the metrics from the library to the goal;
defining a cutoff relevance; and
sorting the input from the at least two sources to define common metrics, wherein the relevance factor for each of the common metrics is equal to or greater than the cutoff relevance.

6. The method of claim 5, wherein the method operation of sorting the input from the at least two sources to define common metrics, further includes;
determining an intersection between the input from the at least two sources.

7. The method of claim 5, wherein the relevance factor is an integer between zero and ten.

8. The method of claim 5, wherein the metrics' database includes at least 450 software metrics.

9. The method of claim 5, wherein the metrics' database includes a metric's name, a metric's identification number and a metric's description for each metric.

10. The method of claim 5, wherein the questions' database includes a question's name, a question's identification number, a question's description and a metric's identification number for each question.

11. The method of claim 5, wherein the goals' database includes a goal's name, a goal's identification number, a goal's description and a question's identification number for each goal, the question's identification number corresponding to a question related to the goal.

12. A computer implemented method for capturing a set of metrics to achieve targeted goals of an organization, the method comprising:
establishing goals of an organization;
identifying questions related to each of the goals, the identifying questions including;
assigning a question relevancy factor to each of the questions indicating a degree of relevance with each of the goals related to the questions;
identifying metrics providing answers to each of the questions, the identifying metrics including;
assigning a metric relevancy factor to each metric indicating a degree of relevance with each of the questions answered by the metrics;
determining a cutoff relevancy; and
proposing a set of metrics where each metric of the set of metrics is assigned the metric relevancy factor having a value that is equal to or greater than the cutoff relevancy, wherein the set of metrics provide answers to questions having the question relevancy factor being equal to or greater than the cutoff relevancy.

13. The method of claim 12, wherein the targeted goals are directed toward software process improvement.

14. The method of claim 12, wherein both the relevancy factor and the weight factor are defined as an integer between zero and ten, zero indicating no relation and ten indicating a high level of relation.

15. The method of claim 12, further including:
constructing a data base engine defining a library of metrics.

16. The method of claim 15, wherein the method operation of constructing a data base engine defining a library of metrics further includes:
defining a questions' database having a plurality of questions related to metrics of the library of metrics; and
defining a goals' database having a plurality of goals related to questions of the questions' database.

17. A computer readable media having program instructions for capturing a set of metrics to achieve targeted goals of an organization, comprising:
program instructions for establishing goals of the organization;
program instructions for identifying questions related to each of the goals, the program instructions for identifying questions including;
program instructions for assigning a question relevancy factor to each of the questions indicating a degree of relevance with each of the goals related to the questions;
program instructions for identifying metrics providing answers to each of the questions, the program instructions for identifying metrics including;
program instructions for assigning a metric relevancy factor to each metric indicating a degree of relevance with each of the questions answered by the metrics;
program instructions for determining a cutoff relevancy; and
program instructions for proposing a set of metrics where each metric of the set of metrics is assigned the metric relevancy factor having a value that is equal to or greater than the cutoff relevancy, wherein the set of metrics provide answers to questions having the question relevancy factor being equal to or greater than the cutoff relevancy.

18. The computer readable media of claim 17, further including:
program instructions for constructing a data base engine defining a library of metrics.

19. The computer readable media of claim 18, wherein the program instruction for constructing a data base engine defining a library of metrics further includes:
program instruction for defining a questions' database having a plurality of questions related to metrics of the library of metrics; and
program instruction for defining a goals' database having a plurality of goals related to questions of the questions' database.
